(19) United States
(12) Patent Application Publication
(10) Pub. No.: US 2011/0259066 A1
(43) Pub. Date: Oct. 27, 2011

(54) METHOD OF COMPOSTING WITH BAGS

(76) Inventor: Nelson G. Wong, Fallston, MD (US)

(21) Appl. No.: 12/766,907

(22) Filed: Apr. 25, 2010

(51) Int. Cl. C05F 11/00

(52) U.S. Cl. 71/11

(57) ABSTRACT

The invention is a method of composting using bags to aerate organic matter.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to the composting of organic matter. More particularly it relates to a method of aerating such matter.

2. Description of Related Art

In the making of compost from organic waste matters, air is needed for microorganisms to digest organic matter into compost. Air deficiency can occur when the matter is packed so tightly that air is not able to flow through as such occurs when the matter is piled. Composting slows as a result. Many practices exist for introducing air into the matter. In home composting, the matter can be manually turned with a fork or other available means. Another common method is the use of containers that tumble to mix and aerate the matter. Perforated tubes consisting of perforated pipes or formed from wired-mesh material are commonly stuck into a compost pile for aeration. Active introduction of air is common in commercial composting. Long rows of material to be composted called “windrows” are turned using a tractor with a backhoe or a specialized windrow-turning machine. Specialized aeration mechanisms to force air into the matter are commonly employed as exemplified in U.S. Pat. Nos. 4,139,640; 4,184,269; 4,288,241; 4,956,002; 5,452,562: 5,538,860; 6,383,803; and 6,439,164. Many container composting methods provides a design for the efficient flowing of air as exemplified in U.S. Pat. Nos. 5,413,934; 5,545,559; 5,695,986; 5,690,249; 5,700,689.

### BRIEF SUMMARY OF THE INVENTION

Most commercial composting methods require fuel and/or electricity to run the air forcing machines. The invention can replace such active aeration methods with a passive method that does not require any expenditure of energy. In home composting, the method provides a more efficient way of introducing air into the material to be composted.

### DETAILED DESCRIPTION OF THE INVENTION

The invention is a method of composting using bags to aerate organic matter. The method consists of placing the matter into bags, piling or assembling the bags together, and allowing the natural crevices and spaces that are created among the bags to flow air into densely packed areas that would be deprived of air. The bags must be constructed of air-permeable material that allows the flow of air to the contained matter.

### BRIEF DESCRIPTION OF THE DRAWINGS

FIG. 1 shows the use of the method for a compost pile.

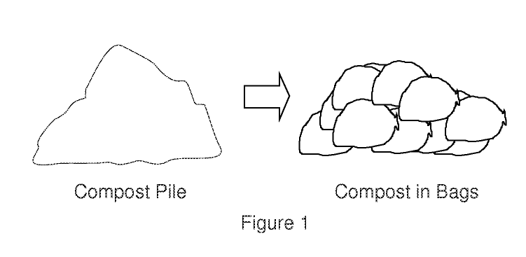

1. A method for introducing air into organic matter to be composted comprising of the following steps:
(a) Select bags constructed of material that is permeable to air
(b) Fill bags with the organic matter
(c) Pile or assemble the bags loosely together
